(19) United States
(12) Patent Application Publication
(10) Pub. No.: US 2013/0211630 A1
(43) Pub. Date: Aug. 15, 2013

(54) FORCE GENERATOR FOR MOUNTING ON A STRUCTURE

(71) Applicants: Stefan Storm, Unterschleissheim (DE); Martijn Priems, Neubiberg (DE)

(72) Inventors: Stefan Storm, Unterschleissheim (DE); Martijn Priems, Neubiberg (DE)

(73) Assignee: EUROCOPTER DEUTSCHLAND GMBH, Donauworth (DE)

(21) Appl. No.: 13/699,788

(22) PCT Filed: May 27, 2011
(86) PCT No.: PCT/DE11/01193

§ 371 Date: Feb. 4, 2013

(30) Foreign Application Priority Data
May 28, 2010 (DE) 10 2010 021 867.7

(51) Int. Cl. F16F 15/02; H02N 2/00; B64D 45/00

(52) U.S. Cl. CPC F16F 15/02; B64D 45/00; H02N 2/001
USPC 701/3; 310/329

(57) ABSTRACT

The invention relates to a force generator (10a) for mounting on a structure (12) in order to introduce vibrational forces in a controlled manner into said structure for affecting vibrations, comprising at least one spring arm (14) on which a flexural arm (22) having an inertial mass (24) and extending in the direction toward the attaching point is fastened, and having at least one piezo transducer (26) at both ends (16, 18) of the spring arm (14), wherein the center of gravity of the inertial mass (24) is disposed in the region of the center of the spring arm (14). Alternatively, two guide springs are disposed on both sides of the spring arm (14) parallel thereto, in order to generate a vibrational motion, wherein the fastening point of the flexural arm (22) comprises an unchanged orientation during the vibrational motion.

The invention relates to a force generator for mounting on a structure in order to introduce vibrational forces into the structure in a controllable manner for influencing vibration.

Force generators are used to generate a desired force by means of a predetermined inertial mass. This force always results from an inertia of the inertial mass, in whatever way it is moved. To generate the highest possible force, the inertial mass may be moved at the highest possible acceleration or deflection, or alternatively, a high force may be generated by the highest possible inertial mass.

These types of force generators are an integral part of a mechatronic system composed of a sensor system, power electronics system, and process computer, and are used, for example, for the targeted introduction of forces into vibrating structures, in particular in aircraft, to counteract or eliminate high vibration levels. Problems arise in particular when there is a more or less intense variation in the frequency of the structure to be controlled, which may be the case, for example, for different operating states of the vibrating structure. These types of different operating states result or are set in a targeted manner, for example in aircraft due to different stages of flight, in particular during takeoff and landing. Especially in rotorcraft, there is a relatively great variation in the rotational speeds of the rotors, and the vibrations caused by the rotors have significant amplitudes which may be very harmful to the pilot and passengers of the rotorcraft (for example, limiting work hours due to increased vibration exposure, “EU Directive 2002/44/CE,” Readability of Instruments).

A force generator is known from DE 10 2005 060 779, for example, in which a bending arm having an inertial mass fastened thereto is provided, and multiple piezoelectric transducers are mounted on the bending arm and which in operation out of phase elastically deform the bending arm, thus inducing the inertial mass to vibrate. Interfering vibrations at selected sensor points at different frequencies may be compensated for by targeted control of the piezoelectric transducers. As a rule, the external force excitation is several times higher than the required active force (by a factor of 4, for example). This means that the force generator is deformed at a higher rate than it can generate displacements itself. Therefore, the piezoelectric transducer must be integrated at a suitable location in order to be able to withstand the high dynamic loads. These types of force generators require a relatively great length of the spring arm, since the piezoelectric transducers may be subjected to only a slight degree of bending deformation, and must not be subjected to tensile stress. Thus, the length of the required installation space is predetermined due to the maximum allowable radius of curvature of the spring arm at the vibration inflection points specified by the allowable flexibility of the piezoelectric transducers.

The position of the inertial mass along the spring arm may be changed to allow adaptation of the force generator to vibrations of greatly differing frequencies. Besides the size, a disadvantage of the previously known systems is the fact that, owing to the design, undesirable torques arise when force is generated using an inertial mass which vibrates on a lever, and vibration is minimized only at the fastening point for the overall system (vibration quenching function).

A force generator is known from the preamble of Claim 1 of DE 10 2006 053 421 A1, in which a bending arm has a U-shaped design, and a piezoelectric transducer is mounted close to the end on the structure side.

An active vibration absorber is known from EP 1 927 782 A1, having two oppositely extending spring arms to which piezoelectric transducers are fastened in pairs at each end. The two free ends of the spring arms are coupled to an inertial mass.

On this basis, the object of the invention is to provide a generic force generator which is characterized by compact size, low undesirable torques, and low electrical power consumption.

This object is achieved according to the invention by the features set forth in the independent claims.

A first approach according to the invention is characterized in that at least one piezoelectric transducer is mounted at both ends of the spring arm, and in addition a bending arm is mounted on the spring arm, at the end of which the inertial mass is fastened. The piezoelectric transducer is pretensioned during the manufacturing process (for example, mechanical pretensioning during the adhesive bonding process and/or utilization of the differing coefficients of expansion in the adhesive bonding process at elevated temperature), so that the piezoelectric transducer experiences no appreciable tensile stress during operation.

If the rotational inertia of the inertial mass is negligible, the center of gravity of the inertial mass is located at the middle of the spring arm; i.e., the length of the bending arm having the inertial mass is one-half the length of the spring arm. The spring arm is thus passively deformed in an S shape (i.e., makes an S turn in a manner of speaking) due to external force excitation, and as a result the (free) vibrating end of the spring arm always has the same constant angle, which essentially corresponds to that of the fixed end. This advantageously results in a parallel displacement of the bending arm contact point. Likewise, an active S-shaped deformation is achieved by the electrical control of the piezoelectric transducers, which likewise results in a parallel displacement of the bending arm contact point. Thus, regardless of external excitation and electrical control, when the two deformations overlap, the bending arm contact point is always forced to undergo a parallel displacement, and therefore the piezoelectric transducers are subjected to load in the same range of magnitude at the two ends of the spring arm. Due to the parallel displacement of the bending arm contact point, it is possible to mount a bending arm at the vibrating end without additional guide elements, the bending arm extending in the direction of the fixed end, parallel to the spring arm (viewed in the idle state), and the inertial mass being mounted at the end of the bending arm.

As a result of this design, force generation is possible which corresponds to a conventional system having a spring arm that is approximately 1.5 times longer, while at the same time, the undesirable torques are only as great as for a conventional system having a spring arm that is 50% shorter, since the center of gravity is situated at one-half the length of the spring arm. This has the advantage that the inertial mass is located much closer to the fixed end, thus significantly reducing the resulting undesirable torques which are introduced into the structure. According to the invention, the inertial mass may be situated at the midpoint of the spring [arm] length or even closer to the fixed end of the spring arm, so that in one embodiment of the invention the undesirable torques are reduced by one-half, and in another embodiment, are reduced almost to zero.

This significant reduction in the vibrations, in particular in aircraft, especially helicopters, will allow operation of such equipment for longer periods, since the exposure time for persons subjected to vibrations (pilots, for example), will be limited by regulation in the future.

According to one advantageous refinement of the invention, a piezoelectric transducer is provided at both ends of the spring arm. It is thus possible to provide both piezoelectric transducers on the same side of the spring arm, which has the advantage of a low degree of manufacturing complexity. Alternatively, the two piezoelectric transducers may be situated on opposite sides of the spring arm, so that the piezoelectric transducers may be controlled in phase.

According to another advantageous refinement of the invention, at both ends of the spring arm two piezoelectric transducers are provided which are opposite one another with respect to the neutral fiber of the spring arm and controlled out of phase. In this configuration, the piezoelectric transducers which are situated crosswise opposite one another are controlled together. This design has the best actuator power, and with regard to the symmetrical configuration and control, the neutral fiber is situated at the middle of the spring arm, regardless of the electrical control, resulting in a symmetrical deflection. In addition, the dimensions of the piezoelectric transducers may be selected independently of the material properties (modulus of elasticity, thickness) of the spring arm.

According to another advantageous refinement of the invention, the spring arm has a rectangular or tapered shape, viewed in the direction of vibration. The rectangular shape is easy to manufacture. A double trapezoidal shape, with or without a narrowed middle area, is preferred as a tapered shape. Due to the tapering a more uniform curvature is achieved, and therefore the piezoelectric transducer is also subjected to more uniform load. The double trapezoidal shape without a narrowed middle area has improved efficiency and a high level of coupling. A defined series spring stiffness may be achieved in the middle area as the result of a narrowed middle area.

According to another advantageous refinement of the invention, the bending arm is one-half the length of the spring arm. This results in a balanced distribution of torque in the spring arm.

Alternatively or additionally, the spring arm may have a longitudinal section with a rectangular or tapered shape. The advantages are essentially the same as described above.

According to one advantageous refinement of the invention in this design, the spring arm includes a center layer and two cover layers coupled thereto, the piezoelectric transducers in each case being situated between the center layer and one of the cover layers. In this way, the piezoelectric transducers may be situated very easily inside the spring arm, and do not necessarily have to be adhesively bonded to the spring arm as has been customary heretofore, thus greatly simplifying installation. The remaining area between the cover layers and the center layer is preferably filled with a suitable filler material, preferably glass-reinforced plastic (GRP), thus joining the various layers to one another and providing a support option for the piezoelectric transducers. Alternatively, the piezoelectric transducers may each be provided with a length almost one-half that of the spring arm, so that only a short region containing filler material remains between the piezoelectric transducers.

One advantageous refinement of this design provides that the cover layers at both ends extend slightly farther than the piezoelectric transducers, and are connected there to the center layer via support sections, the piezoelectric transducers being supported on the support sections so that only the center layer is present in the middle area of the spring arm. This design allows the middle area of the spring arm to have a more flexible design, which has the advantage that the series stiffness of the spring arm and the bending arm is reducible.

Another advantage of this design according to the invention is that, due to the S-shaped deformation of the spring arm, more energy may be converted than with a simple bending bar, which results in higher efficiency of the force generator.

Another advantageous design of the invention provides that two guide springs are situated on both sides of the spring arm, parallel thereto, each of the first ends of the guide springs likewise being fastened to the structure, and each of the second ends of the guide springs, together with the vibrating end of the spring arm, being fixedly mounted on a connecting part, and the bending arm being mounted on the connecting part. In this design, the connecting part is forcibly guided, so that, except for the shortened areas resulting from the bending deformations, it vibrates parallel to the fixed ends. Due to this forced guiding, it is in turn possible for the bending arm to be longer than in the previously mentioned embodiment (in which the inertial mass is located at the middle of the spring arm), and therefore the inertial mass may be situated as closely as desired to the structure or the fixed end of the spring arm. It is even possible for the center of gravity of the inertial mass to be located directly at the fixed end, so that torques may be completely avoided, and therefore only the desired high forces caused by the vibration of the inertial mass arise.

An alternative design of the invention provides that at least two spring arms provided with piezoelectric transducers are provided parallel to one another, the fixed ends of the spring arms being fastened to the structure, and the vibrating ends of the spring arms being fixedly connected to one another via a connecting part, the bending arm being mounted on the connecting part. In this design, the forced vibration of the connecting part parallel to the two fixed points is caused by the at least two spring arms of the same type, which are deformable in parallel toward one another in an S shape due to the matching control of the pairs of piezoelectric transducers. Also in this design, the inertial mass may be brought as close to the structure as desired. The number of spring arms situated in parallel and provided with piezoelectric transducers also indicates the factor by which the generatable force of a spring arm is multiplied.

According to another advantageous refinement of the invention, a second spring arm extending in the opposite direction and having piezoelectric transducers attached at both ends is mounted at the end of each spring arm, and a bending arm having an inertial mass is mounted at the other end of each spring arm. The active lift of the inertial mass, and thus the generatable force, may thus be significantly increased.

One advantageous refinement of the invention provides that the inertial mass and/or the bending arm together with the inertial mass is/are exchangeable. A “serial system” having little complexity of design may thus be provided, in which an active base system composed of the spring arm or the spring arms having mounted pairs of piezoelectric transducers may be coupled to an exchangeable passive resonator system which may be adapted to greatly differing vibration conditions. The active base system, which is always the same and is composed of the spring arm together with the piezoelectric transducers, may be the basis by default, and an adaptation to the frequency of operation may be made using an adapted resonator system (either only an exchangeable inertial mass or an exchangeable system composed of an inertial mass together with a bending arm). The main part of the mass motion is assumed to be passively weak here, and the dynamic forces thus generated cause only slight deformation of the active system, so that practically no tensile forces occur in the pretensioned piezoelectric ceramics. This construction thus allows increased freedom of design for the overall system. Thus, a key advantage of this refinement is the “family concept,” so that the force generator according to the invention is adaptable to numerous applications, such as aircraft of different sizes, since it is only necessary to adapt the resonator part, which has a simple design.

A second approach according to the invention for achieving the underlying object is characterized in that two lever arms extending in opposite directions are provided on both sides of the spring arm in the area of the fixed end, and two piezoelectric transducers which are controllable out of phase are supported at their respective one end on the structure, and at their respective second end are supported on the two lever arms for mutually acting bending of the spring arm. In this design, the piezoelectric transducers are situated next to the spring arm in a contact-free manner, which not only simplifies installation, but for the first time also allows repair in the event of damage to a piezoelectric transducer.

As a result of the piezoelectric transducers being supported at both ends on the respective other component (of the structure or the lever arms), and being compressed by approximately 0.1% and thus pretensioned during installation, there is also no danger of undesirable tensile stresses in the piezoelectric crystal, thus reducing the risk of damage.

This design has the advantage of high mechanical coupling of the system and low pretensioning, since there is no undesirable parallel stiffness due to glued-on piezoelectric transducers, and the piezoelectric transducer is only slightly curved, since solid state hinges may be situated at both ends of the piezoelectric transducers. In addition, the length of the piezoelectric elements may be selected independently of the spring length, since the desired introduction of torque may be specified by the length of the lever arms (either short piezoelectric transducers with short lever arms, or long piezoelectric transducers with long spring arms). Another advantage is that larger active paths may be generated on the lever arm, so that the introduction of force may take place at an optimal distance from the neutral phase. Therefore, no high pretensioning forces are necessary as in conventional systems. A further advantage is that the fastening of the inertial mass may be dimensioned with the spring arm close to the fixed end (of the fixed point) and independently of the dimensioning of the actuator system (piezoelectric transducers and lever arm). Therefore, lower torques occur at the fixed end, since the inertial mass is located closer to the fixed end than in conventional systems.

One refinement of this design provides that the fixed end of the spring arm is designed as a preferably convex pitch surface which is supported against a conversely shaped, i.e., preferably concave, opposite pitch surface on the structure side. Thus, in this design the spring arm is not mechanically fastened to the structure, but instead is only pressed against the structure by the pressure of the two piezoelectric transducers. Advantageously, no restoring torques arise in this design. In addition, the pitch surface on the spring arm side may be convex, and on the structure side may be concave, in order to achieve essentially the same effect.

Another advantageous refinement of the above-mentioned design is that the two piezoelectric transducers which contact the lever arms at their other ends are fastened to one intermediate support each, and the two intermediate supports are in each case fastened to an additional piezoelectric transducer, each of which extends parallel to the two piezoelectric transducers and which is controllable out of phase with same, and at its other end is supported on the structure. In this design, the two piezoelectric transducers, in each case connected via an intermediate support, cooperate in the manner of a single piezoelectric transducer having the overall length of two piezoelectric transducers mechanically “connected one behind the other.” A flexible spring element which ensures practically constant pretensioning of the piezoelectric transducers is also necessary between the structure and the intermediate support. At the same time, this pretensioning element serves to prevent buckling of the piezoelectric transducers perpendicular to the direction of extension. Thus, with a compact configuration and a short overall length a longer active path is achieved, as the result of which a greater distance from the neutral fiber of the spring arm or a shorter overall length is possible. At the same time, the configuration has a simpler design, so that the actuator system may also be supported on the structure side on which the spring arm is also mounted.

One advantageous refinement of this design provides that the two piezoelectric transducers which contact the lever arms at their respective other ends contact a centrally rotatably fixed rocker part, and two additional piezoelectric transducers contact at the rocker part, each extending parallel to the two first piezoelectric transducers and being controllable out of phase with same, and at their other ends being supported on the structure. The piezoelectric transducers are pretensioned by compression during installation. This design of a folded actuator system has the advantage that, in contrast to the previously described embodiment, no pretensioning spring connected in parallel is necessary, thus resulting in a greater active lift.

A third approach according to the invention for achieving the underlying object is characterized in that three mutually parallel spring arms are provided, each being supported on the structure at one end, and at the other end being fastened to a connecting part, two projecting lever arms being provided on the middle spring arm, and on which two piezoelectric transducers are each supported at their one end, and at their respective second end the piezoelectric transducers each being supported via a bar segment connected to the connecting part, wherein the bar segments, the connecting part, and the piezoelectric transducers together form the inertial mass. In this design, practically the entire installation space may be used for the inertial mass, which helps to reduce the overall size. Since the piezoelectric actuator system is an integral part of the inertial mass, this also results in a lower mass of the overall system, and thus, a more favorable ratio of the inertial mass to the total mass. In addition, the middle spring arm may have a thinner design. It is also possible to remove the introduction of force into the middle spring arm to a location very far from the fixed point on the structure side. At the same time, the introduced torques are supported by the two outer spring arms. Furthermore, the center of gravity may be located close to the structure fixed point in order to reduce mechanical torques.

One advantageous refinement of this design provides that the distance between the bar segments and the outer spring arms is selected in such a way that stops are formed which prevent damage to the force generator due to excessive deflections. Thus, for the deflections of the inertial mass, a type of stop may be provided which prevents impermissibly high deflections at the resonance point, and thus prevents damage.

The invention is explained in greater detail below with reference to the accompanying drawings. Identical components are denoted by the same reference numerals in the figures, which show the following:

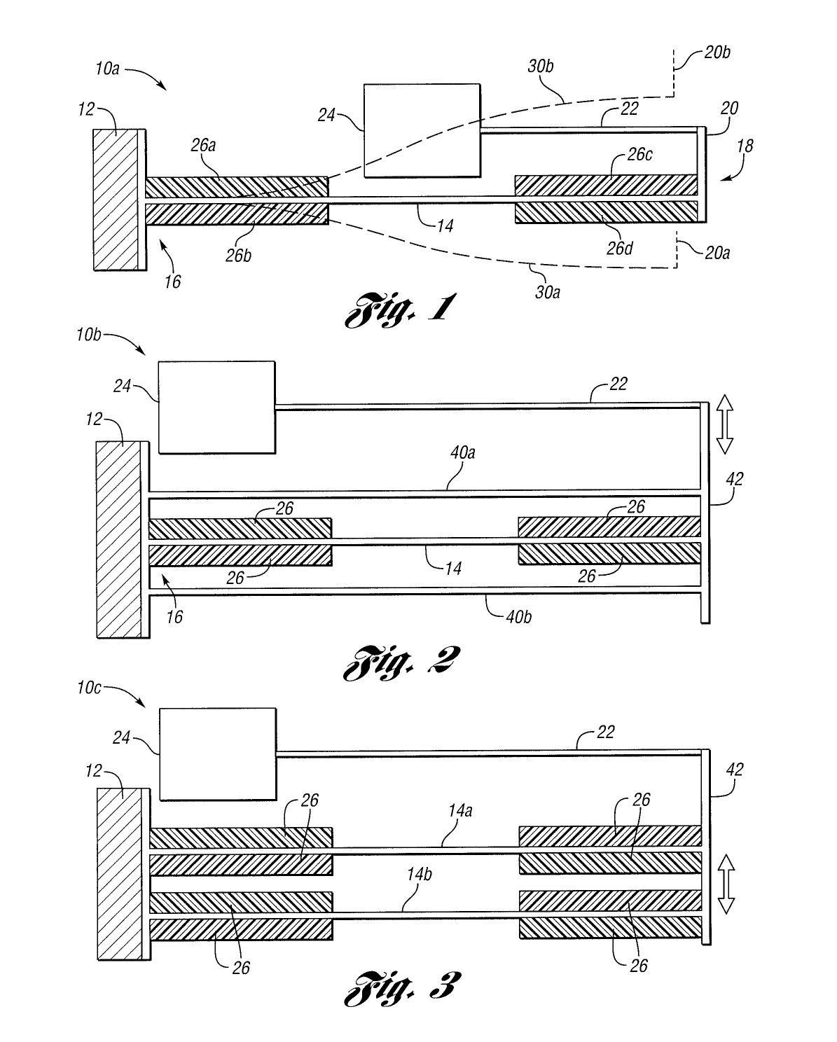

FIG. 1: shows a schematic view of a first embodiment of the invention;

FIG. 2: shows a schematic view of a second embodiment of the invention;

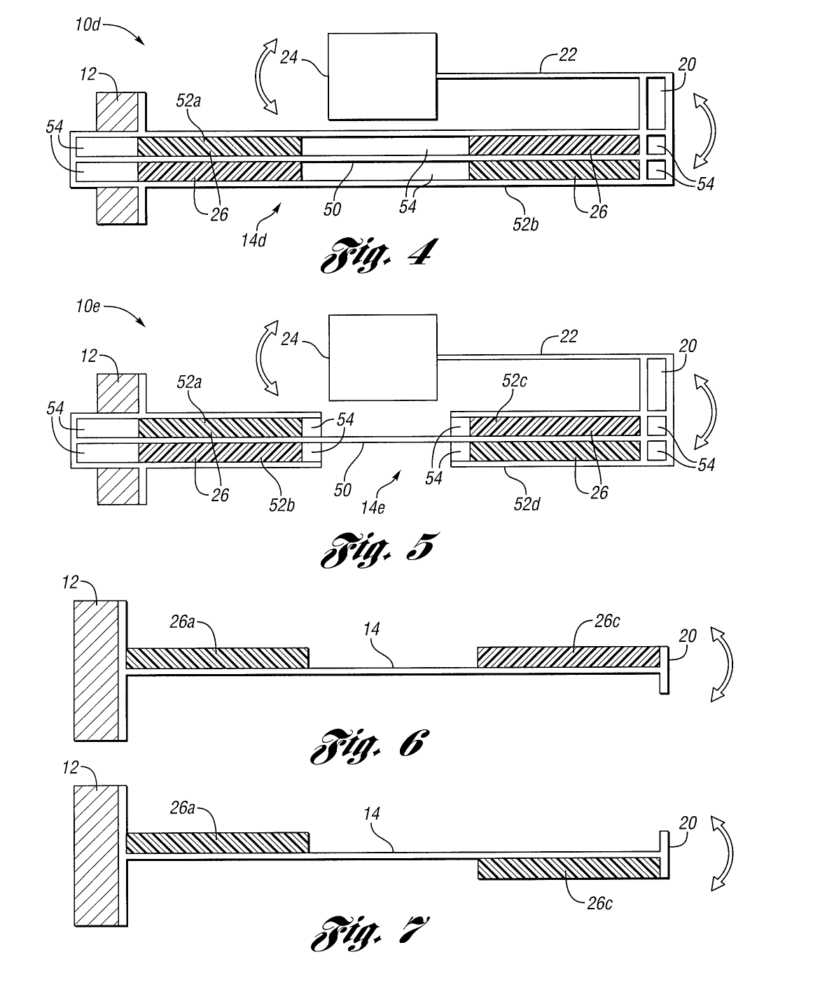

FIG. 3: shows a schematic view of a third embodiment of the invention;

FIG. 4: shows the embodiment according to FIG. 1, with a special design of the spring arm;

FIG. 5: shows the embodiment according to FIG. 1, with an alternative design of the spring arm;

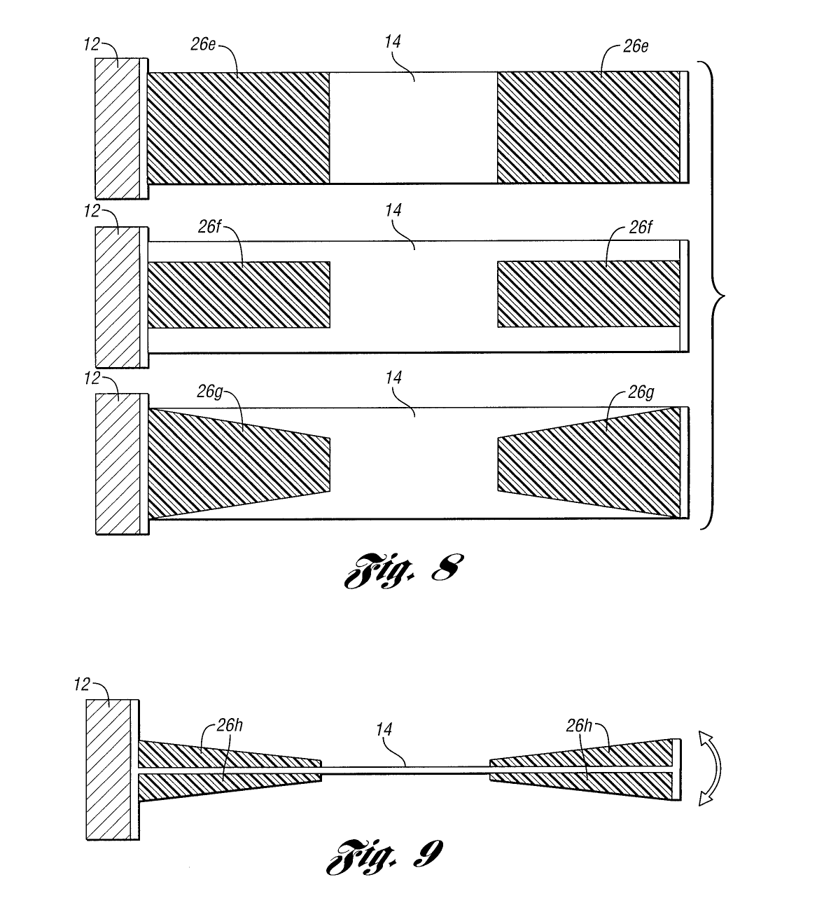

FIGS. 6 and 7: show two further embodiments having only two piezoelectric transducers;

FIG. 8: shows three alternative designs of piezoelectric transducers;

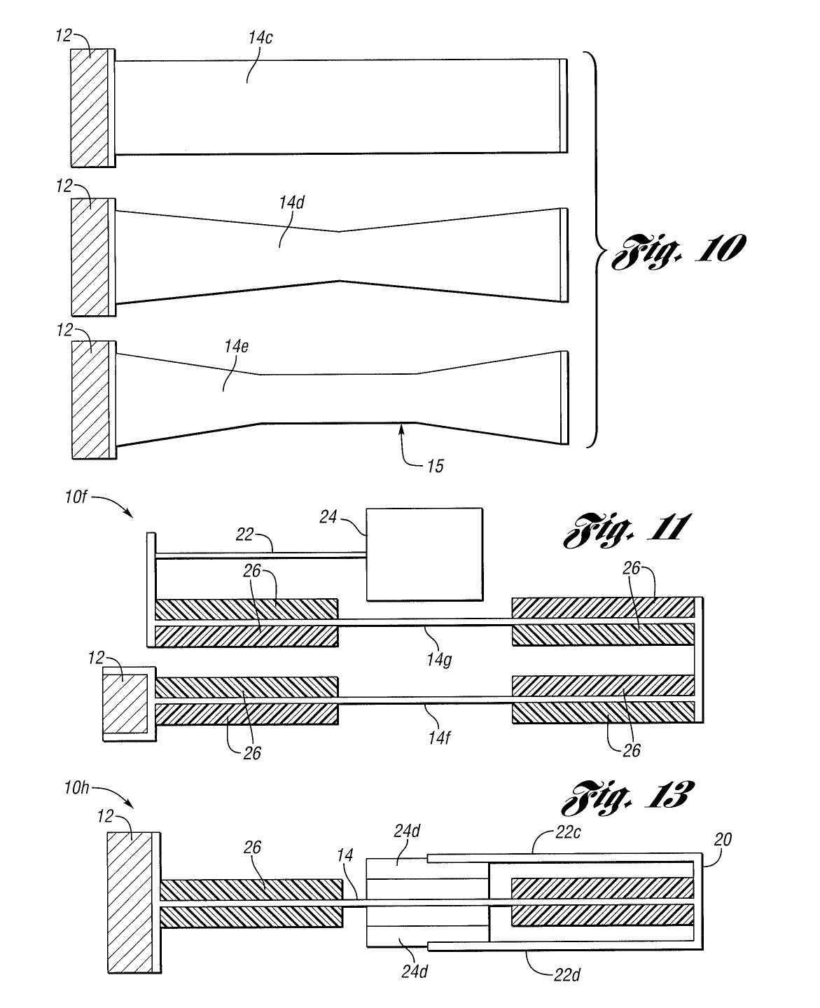

FIG. 9: shows an embodiment having trapezoidal piezoelectric transducers;

FIG. 10: shows three embodiments of spring arms;

FIGS. 11-20: show further embodiments of force generators;

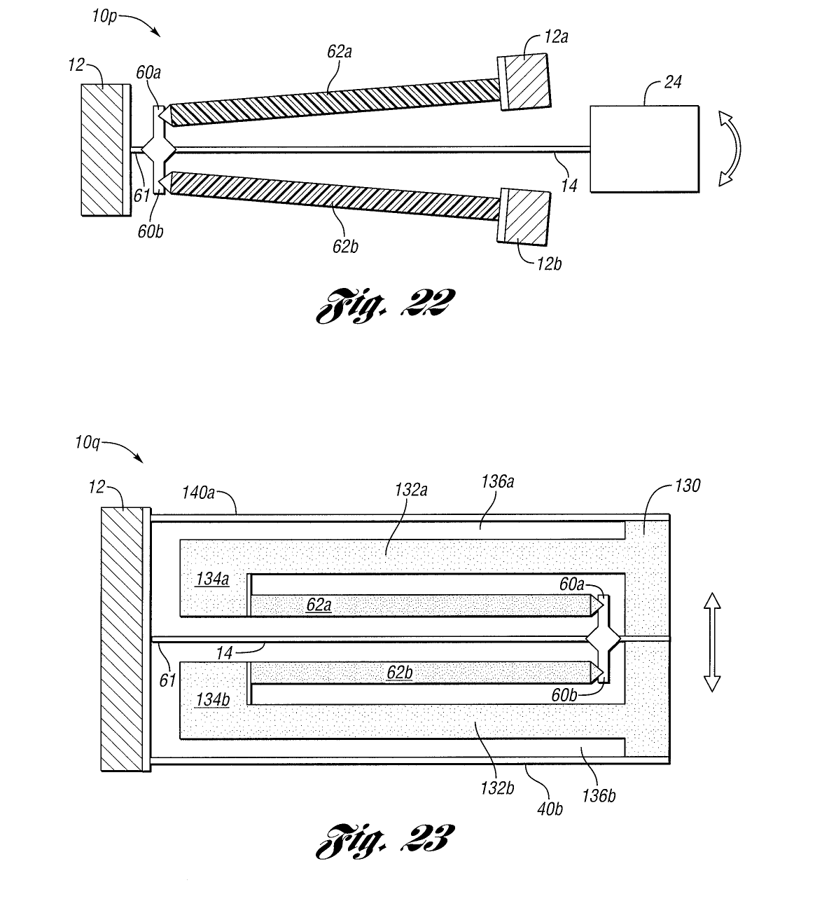

FIG. 21: shows a schematic illustration of an application in a helicopter;

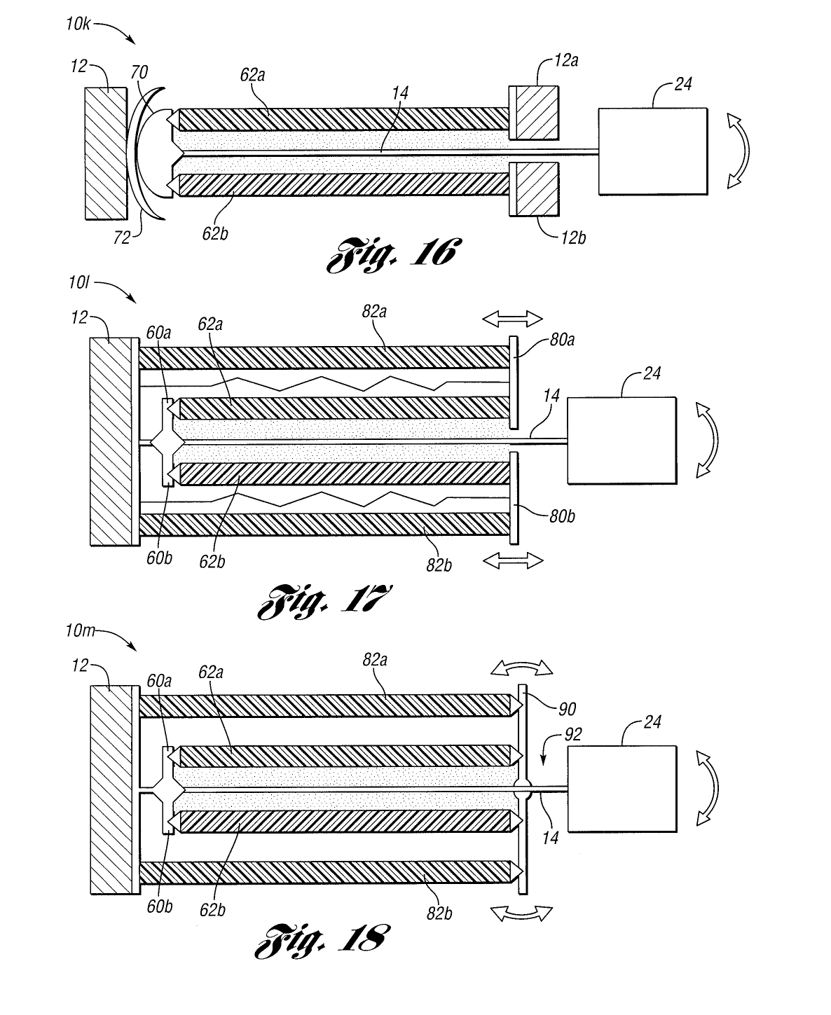

FIG. 22: shows an embodiment which represents a modification of the design according to FIG. 15; and

FIG. 23: shows another embodiment of a force generator.

FIG. 1 schematically illustrates a first embodiment of a force generator 10a which is fastened to a structure 12. The force generator 10a includes a spring arm 14 whose one end, the fixed end 16, is fixedly attached to the structure 12. A bending arm 22 which is preferably oriented parallel to the spring arm 14 is mounted on the oppositely situated vibrating end 18 of the spring arm 14 via a connecting part 20. An inertial mass 24 is fastened to the free end of the bending arm 22. The spring arm 14 is preferably made of GRP, although other fiber composites or metal materials may be used. The inertial mass 24 weighs approximately 1 to 10 kg, and its center of gravity is located at the middle of the spring arm 14.

At the fixed end 16 of the spring arm 14, piezoelectric transducers 26a, 26b are adhesively bonded thereto on both sides or permanently affixed over their entire surface in some other way. Similarly, two additional piezoelectric transducers 26c, 26d are affixed over their entire surface to both sides of the spring arm 14 in the area of the vibrating end 18. It is pointed out that instead of each of the illustrated piezoelectric transducers 26, two or more piezoelectric transducers may be oriented in parallel, which then may be controlled together.

By means of a control circuit, not illustrated, the piezoelectric transducers 26a, 26b, 26c, 26d are now controlled in a crosswise manner, so that the piezoelectric transducers 26a and 26d, and 26b and 26c, respectively, having the same crosshatching are controlled together (this also applies to the other figures). If, for example, the piezoelectric transducers 26a and 26d are activated (the other two piezoelectric transducers 26b and 26c at the same time being in the idle state), both piezoelectric transducers 26a and 26d elongate and cause an S-shaped bending of the spring arm 14 according to the dashed line 30a, which is greatly exaggerated for the sake of clarity. The connecting part 20a retains essentially the same orientation.

If the piezoelectric transducers 26a and 26d are now switched off and instead the piezoelectric transducers 26b and 26c are activated, the first piezoelectric transducer becomes shorter and the second piezoelectric transducer becomes longer, so that the spring arm 14 bends in an S shape in the opposite direction according to the dashed line 30b, likewise greatly exaggerated for the sake of clarity. Thus, by the targeted alternating activation of the pairs of piezoelectric transducers, a forced vibration is generated in the spring arm 14 which propagates over the bending arm 22 to the inertial mass 24, causing the inertial mass to vibrate, resulting in an oscillating force at the fixed end 16. In addition, an oscillating torque, undesirable per se, arises over the lever arm between the fixed end 16 and the center of gravity of the inertial mass 24, and is transmitted into the structure at the fixed end 16. Since due to the design according to the invention the center of gravity of the inertial mass 24 is located 50% closer to the fixed end 16 than in conventional force generators, in which the inertial mass 24 is situated at the vibrating end 18, these torques are 50% smaller than in the prior art.

In this embodiment, according to one preferred design the bending arm 22 having the inertial mass 24 is detachably mounted on the connecting part 20, so that the spring arm 14 having the piezoelectric transducers 26 and the connecting part 20 (together with a control device, not illustrated), in addition to sensors for detecting the vibrations in the structure 12, form an active base system. On the other hand, the bending arm 22 and the inertial mass 24 form a passive resonator system which may be adapted to the particular operating conditions. Thus, the force generator according to the invention may be used in a modular manner in various applications for very different vibration conditions, since the same active base system may always be used, while the passive resonator system is selected based on the vibration conditions. Alternatively, the bending arm 22 may be nondetachably mounted on the connecting part 20 and thus be associated with the active base system, so that only inertial masses 24 having different weights form the exchangeable passive resonator system. These types of sensors preferably detect the vibrations in all three directions.

FIG. 2 illustrates a second embodiment of the force generator 10b, in which two guide springs 40a, 40b are provided on both sides of the spring arm 14 having the piezoelectric transducers 26, the guide springs at their respective one end likewise being mounted on the structure 12, and at their respective other end being mounted on a connecting part 42, to which the spring arm 14 is likewise fixedly mounted. As a result of the two guide springs 40a, 40b, which may correspond to the spring arm 14 with regard to material properties and dimensions, the spring arm 14 is bent in an S shape due to the excitation of the piezoelectric transducers 26, and as a result of the forced guiding by both guide springs 40a, 40b a quasi-oscillating motion of the connecting part 42 is achieved, in particular in the same manner as indicated by the lines 30a, 30b in FIG. 1. The bending arm 22 is mounted on the connecting part 42, and the inertial mass 24 is in turn mounted on the bending arm. In contrast to the design according to FIG. 1, however, the bending arm 22 is much longer, so that the center of gravity of the inertial mass 24 is more or less at the location of the fixed point 16. Provided that the structure 12 has a suitable shape, the center of gravity of the inertial mass 24 may be at the same location as the fixed point 16, so that no lever arm remains between the fixed point 16 and the center of gravity of the inertial mass 24, and therefore undesirable torques may largely be avoided.

FIG. 3 illustrates a third embodiment of the force generator 10c, in which two identical spring arms 14a, 14b are oriented parallel to one another, and mounted on the structure 12 and also on the connecting part 42. The bending arm 22 is mounted on the connecting part 42, and the inertial mass 24 is in turn mounted on the bending arm. Similarly as in FIG. 2, due to the parallel position of the two spring arms 14a, 14b a largely oscillating motion of the connecting part 42 is achieved. For this purpose, the respective piezoelectric transducers 26 on both spring arms 14a, 14b are controlled in parallel.

The same as in the design according to FIG. 1, in the designs according to FIGS. 2 and 3 a division into an active base system, composed of the spring arms 14, 14a, 14b, 40a, 40b together with the connecting part 42, and an exchangeable passive resonator system having the inertial mass 24 and optionally the bending arm 22, is practical.

FIG. 4 illustrates a fourth embodiment of the force generator 10d, which for the most part corresponds to the design 10a in FIG. 1. The main difference is that the spring arm 14d is composed of three layers, namely, a center layer 50 and two cover layers 52a, 52b. On both sides of the center layer 50, piezoelectric transducers 26 are situated at both ends of the spring arm 14d, but do not have to be affixed, and in particular do not have to be adhesively bonded. This is because material areas 54 are provided at the two ends of the spring arm 14d and also at the middle, and are fixedly connected to the layers 50, 52a, 52b, resulting in an integral structure of the spring arm 14d. At the same time, the piezoelectric transducers 26 may be supported on the material areas 54 at both ends, and may thus convert their longitudinal extension into an S-shaped deformation of the spring arm 14d (analogous to the lines 30a, 30b in FIG. 1).

FIG. 5 illustrates a fifth embodiment of the force generator 10e, which for the most part corresponds to the design in FIG. 4. The only important difference is that the outer cover layers of the spring arm 14e are not continuous; i.e., cover layers 52a, 52b are provided at the end on the structure side, and cover layers 52c, 52d are provided at the vibrating end. In the middle area the spring arm 14e is much more flexible than the spring arm 14d, which has the advantage that a lower series spring stiffness is achievable.

FIGS. 6 and 7 illustrate two embodiments in which only two piezoelectric transducers 26a, 26c and 26a, 26d, respectively, are mounted on the spring arm 14. These embodiments have a simpler construction than the design having four piezoelectric transducers as illustrated in FIGS. 1 through 5.

FIG. 8 illustrates three alternative designs of piezoelectric transducers, viewed in the direction of vibration. In the design according to the top illustration, the piezoelectric transducers 26e have the same width as the spring arm 14, as the result of which a maximum actuator power is achievable. In the design according to the middle illustration, the piezoelectric transducers 26f are narrower, which ensures mechanical protection of the piezoelectric transducers. In the design according to the bottom illustration, the piezoelectric transducers 26g have a trapezoidal shape, which allows optimized efficiency and a higher level of coupling.

FIG. 9 illustrates an embodiment in which the piezoelectric transducers 26h have a trapezoidal thickness, which allows a higher level of coupling and an optimizable adaptation to the actuator properties. Another advantage is a lower flexural strength at the thinner ends, i.e., in the middle area of the spring arm 14. When d33 piezoelectric crystals are used for the piezoelectric transducers 26h, a constant extension may be achieved. On the other hand, when d31 piezoelectric crystals are used it is possible to achieve an increased extension at the thinner ends.

FIG. 10 illustrates three embodiments of spring arms. In the embodiment according to the top illustration, the spring arm 14c has a rectangular contour viewed in the direction of vibration, which simplifies manufacture. In the embodiment according to the middle illustration, the spring arm 14d has a double trapezoidal shape, as the result of which the efficiency is optimizable and a high level of coupling is achievable. In the embodiment according to the bottom illustration, the spring arm 14e has a double trapezoidal shape with a tapered middle section 15, by means of which a defined series spring stiffness in the middle section 15 is achievable by selection of the degree of narrowing. In the same way, the spring arm 14, also viewed in the longitudinal section, may have a double trapezoidal shape, i.e., being thicker at the ends and thinner in the middle, with or without a tapered middle section, similarly resulting in the advantages described above. Of course, it is also possible to taper the spring arm(s) in both directions.

FIG. 11 illustrates another embodiment of the force generator 10f in which two spring arms 14f, 14g are mounted one behind the other, and both spring arms 14f, 14g are provided with piezoelectric transducers 26. The various embodiments of the piezoelectric transducers 26e through 26h described above may be applied. This embodiment allows an increase in the active lift, and thus, in the generated force.

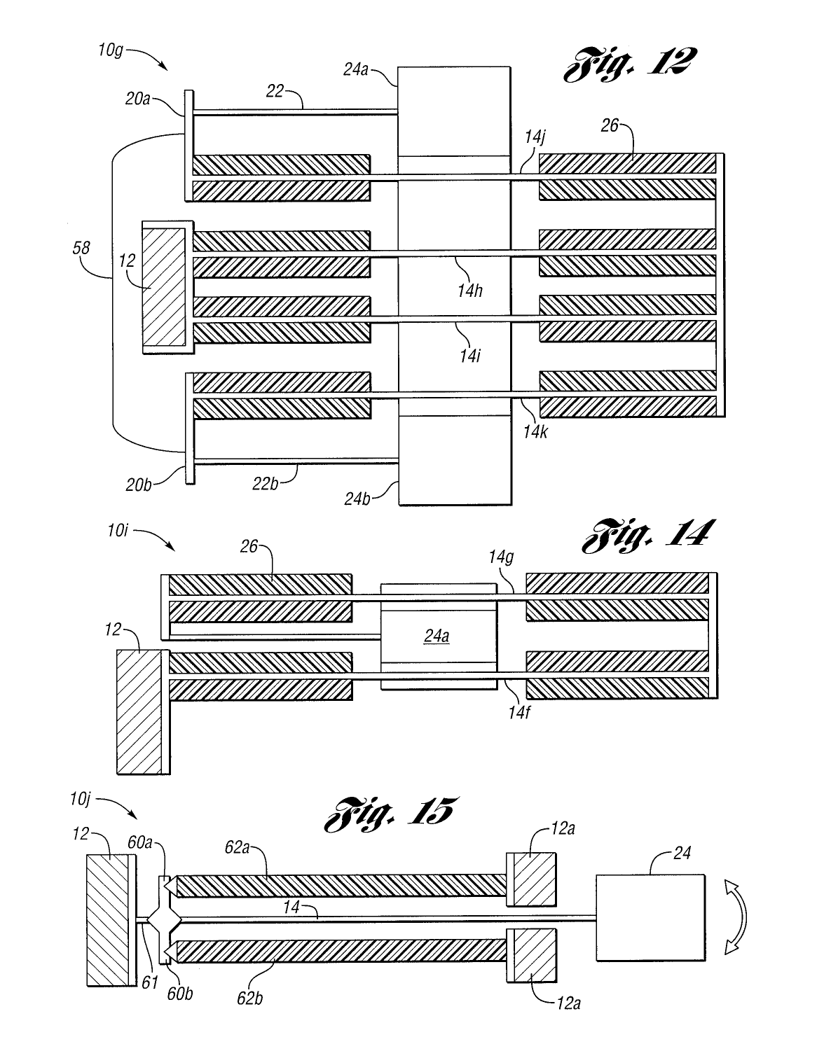

FIG. 12 illustrates another embodiment of the force generator 10g which has similarities to the designs according to FIGS. 3 and 11, in that two spring arms 14h, 14i are provided, fastened to the structure 12 on one side, on which further spring arms 14j, 14k are mounted, and to which two bending arms 22a, 22b, respectively, are in turn mounted via connecting parts 20a, 20b, respectively. Inertial masses 24a, 24b are in turn mounted on the bending arms 22a, 22b respectively. The connecting parts 20a, 20b are optionally fixedly coupled to one another via a coupling element 58 in order to ensure synchronized vibration of the two inertial masses 24a, 24b, respectively. The inertial masses 24a, 24b may also be connected to one another. Another advantage of this design is that the structure parts 12a allow limitation of the vibrational deflection of the spring arm 14. An actuator system connected in parallel and in series is achieved as a result of this embodiment.

FIG. 13 illustrates another embodiment of the force generator 10h which is similar to the design according to FIG. 1. In contrast to FIG. 1, two bending arms 22c, 22d extending in parallel are provided on the connecting part 20, a ring-shaped inertial mass 24d which encloses the spring arm 14 being mounted on the bending arms. In the idle state, the center of gravity of the inertial mass 24d is thus located in the spring arm 14, so that no additional laterally acting torques arise.

FIG. 14 illustrates another embodiment of the force generator 10i in which, similarly as in FIG. 11, two spring arms 14f, 14g are mounted one behind the other, and a double T-shaped inertial mass 24e is mounted on the second spring arm 14g. The center of gravity of the inertial mass 24e is thus centrally located, so that no additional laterally acting torques arise.

FIG. 15 illustrates another embodiment of the force generator 10j in which, the same as in the previous embodiments, a spring arm 14 is fixedly attached to the structure 12. However, at the free end of the spring arm 14 the inertial mass 24 is indirectly fastened so that it is detachable and therefore exchangeable. However, no piezoelectric transducers are mounted on the spring arm 14 itself; instead, two lever arms 60a, 60b extend from the spring arm 14 in the vicinity of the fixed point 61 of the spring arm 14, and two piezoelectric transducers 62a, 62b in turn contact the lever arms and are supported on a structure 12a, which is part of the structure denoted by reference numeral 12, at their respective opposite ends. As indicated by the crosshatching, the two piezoelectric transducers 62a, 62b are controlled out of phase, so that they elongate in alternation and thus introduce a bending torque into the spring arm 14 via the lever arms 60a, 60b, respectively. The spring arm 14 therefore has no stiffness produced by piezoelectric transducers, and the piezoelectric transducers 62a, 62b are selectable independently of the length of the spring arm 14.

FIG. 16 illustrates another embodiment of the force generator 10k, which for the most part corresponds to the design 10j in FIG. 15. The main difference is that the spring arm 14 is not fixed to the structure 12, but instead terminates at an end piece 70 having a concave pitch surface, the lever arms for the piezoelectric transducers 62a, 62b likewise being integrated into the end piece 70. The structure 12 has a concave opposite surface 72, so that no undesirable restoring torques are present in the spring arm 14.

FIG. 17 illustrates another embodiment of the force generator 10l which is similar to that in FIG. 15. In contrast to the design 10j, the ends of the piezoelectric transducers 62a, 62b opposite from the lever arms 60a, 60b are not supported on the structure, but instead are fixed to intermediate supports 80a, 80b. Additional piezoelectric transducers 82a, 82b are mounted on these intermediate supports 80a, 80b, respectively, and with their respective opposite ends are supported on the structure 12. As indicated by the crosshatching of the piezoelectric transducers 62a, 62b, 82a, 82b, the mechanically connected piezoelectric transducers 62a, 82a and 62b, 82b are controlled out of phase, so that the intermediate supports 80a, 80b oscillate due to the motion of the piezoelectric transducers 82a and 82b in the axial direction of the spring arm 14 (out of phase relative to one another), and this oscillating motion is transmitted to the lever arms 60a, 60b via the inner piezoelectric transducers 62a and 62b, respectively, and intensified by their own motion, thus setting the spring arm 14 in vibration. The intermediate supports 80a, 80b are pulled in the direction of the structure 12 by means of two pretensioning springs 64, thus preventing lateral tilting of the system.

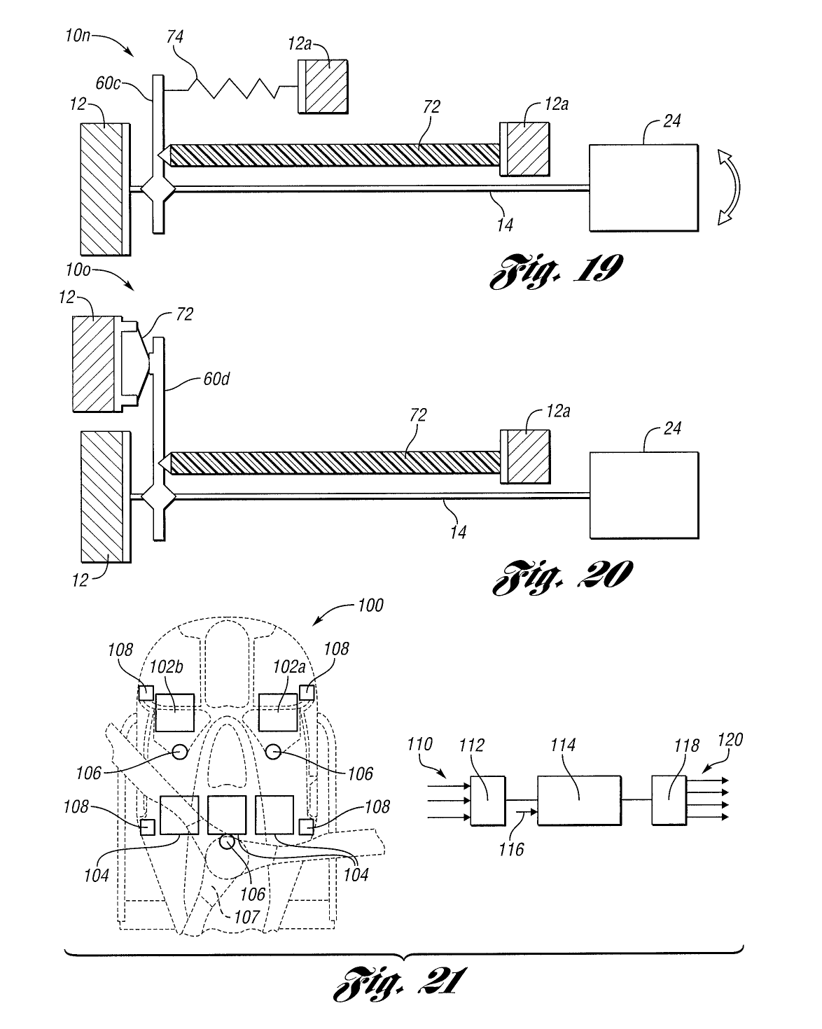

FIG. 18 illustrates another embodiment of the force generator 10m which essentially corresponds to the design 10l in FIG. 17. The main difference is that two different intermediate supports (FIG. 17: 80a, 80b) are not present; instead, all four piezoelectric transducers 62a, 82a and 62b, 82b are supported on a rocker 90 which is suspended on the structure 12 at a center of rotation 92.

FIG. 19 illustrates another embodiment of the force generator 10n, which differs from the previously described embodiments in that only one piezoelectric transducer 72 is present, which on the one hand is supported on the structure 12a and on the other hand is supported on a lever arm 60c. In addition, a spring 74 is fastened to the lever arm 60c, and at the other end is fixed to the structure 12a. The embodiment has a simpler design, and allows single-phase electrical control of the piezoelectric transducer 72. The spring 74 shown in FIG. 19 is designed as a tension spring. Alternatively, it is possible to design the spring as a compression spring. It is also possible to mount the spring 74 (as a tension spring or a compression spring) not on the lever arm 60c, but instead on a lever arm, not shown, which extends oppositely from the lever arm 60c, as in FIG. 17, in which the lever arm 60b extends oppositely from lever arm 60a.

FIG. 20 illustrates another embodiment of the force generator 10o which is similar to that in FIG. 19. In contrast, instead of a tension spring a degressive compression spring 76 is provided, which is supported between the structure 12 and the lever arm 60d. The compression spring 76 is preferably designed as a pretensioned disk spring. The advantage of the degressive compression spring 76 is that the active lift due to the decreasing pretensioning force of the compression spring 76 during the extension of the piezoelectric transducer 72 is re-intensified, which increases the vibration excitation. This embodiment also allows a smaller length of the piezoelectric transducers, and thus a smaller size of the overall force generator. The compression spring 76 may also be mounted on a second lever arm (not shown) which extends oppositely from the lever arm 60d, as in FIG. 17, in which the lever arm 60b extends oppositely from the lever arm 60a.

All of the above-mentioned embodiments of force generators 10a through 10o are controlled by a control unit, not illustrated, which has one or more vibration sensors for detecting the vibrations at one or more positions in the structure which are to be compensated for, and in one or more directions, and to excite the piezoelectric transducers 26 with a frequency such that these vibrations are absorbed to the greatest extent possible by the introduction of oscillating forces into the structure 12.

FIG. 21 illustrates one application of force generators according to the invention in a schematically illustrated helicopter 100. This helicopter 100 includes two pilot seat areas 102a, 102b and multiple passenger seats 104. Mounted on the cabin floor, not illustrated, are three sensors 106 which detect the vibrations generated by the rotor 107 at these locations, in each case in all three spatial directions, as well as four force generators 108. The sensors 106 are connected via lines 110 (indicated only in the block diagram shown underneath) to an input filter unit 112 in which low pass filters, preferably Butterworth filters, are provided for eliminating high-frequency components in order to avoid aliasing effects in the signals of the sensors 106. A controller 114 is situated downstream from the input filter unit 112, and as further input variables 116 has the rotor rotational speed of the drive rotor, not shown, of the helicopter 100, and individually controls the four force generators 108 as a function of the signals of the sensors 106 and the rotor speed 116 via a driver unit 118 and connecting lines 120. In this regard, it is important that minimizing the vibrations for the pilot seat areas 102a, 102b and/or the passenger area 104 is possible by means of suitable control. The sensors 106 or the force generators 108 do not have to be situated in direct proximity of the areas 102a, 102b, 104 for which vibrations are to be minimized.

FIG. 22 illustrates another embodiment of the force generator 10p which for the most part corresponds to the design in FIG. 15; therefore, the same reference numerals as in FIG. 15 are used, and with regard to the design and function, reference is made to the description for that figure. In contrast to the design in FIG. 15, in the present design the two piezoelectric transducers 62a, 62b are oriented at an angle with respect to the spring arm 14. This angle may be selected to have practically any value, for example 90° with respect to the center axis of the spring arm 14.

FIG. 23 illustrates another embodiment of the force generator 10q which includes three mutually parallel spring arms 14, 140a, 140b, each fastened at one end to the structure 12. The respective other ends are mounted on a connecting part 130. Two bar segments 132a, 132b project from this connecting part 130, and preferably extend essentially parallel to the spring arms and have support projections at the respective free end 134a, 134b. The middle spring arm 14 has two lever arms 60a, 60b which project approximately perpendicularly. Two piezoelectric transducers 62a, 62b are supported on the one hand on the support projections 134a, 134b, respectively, and on the other hand are supported on the lever arms 60a, 60b, respectively. As a result of the alternating excitation of the piezoelectric transducers 62a, 62b in conjunction with the three parallel spring arms 14, 140a, 140b, the entire inertial mass, essentially composed of piezoelectric transducers 62a, 62b, bar segments 132a, 132b having support projections 134a, 134b, and connecting part 130, is set in vibration, in particular in an S-shaped inflection. The gap 136a, 136b between the outer spring arms 140a, 140b, respectively, and the bar segments 132a, 132b, respectively, is preferably wide enough so that for a certain maximum deflection, these components approach one another, and the maximum deflection of the inertial mass may be effectively limited to a value which prevents damage.

1. Force generator for mounting on a structure (12) in order to introduce vibrational forces into the structure in a controllable manner for influencing vibration, comprising at least one spring arm (14) having a fixed end (16) for fastening to the structure (12), and having a vibrating end (18) to which an inertial mass (24) is fastened via a bending arm (22) extending in the direction of the fixed end (16), at least one piezoelectric transducer (26) being mounted on the spring arm (14) for the bending deformation thereof, characterized in that at least one piezoelectric transducer (26) is mounted at both ends (16, 18) of the spring arm (14), and the center of gravity of the inertial mass (24) is located at the middle of the spring arm (14).

2. Force generator according to one of the preceding claims, characterized in that the spring arm (14) has a longitudinal section with a rectangular or tapered shape.

3. Force generator according to claim 1, characterized in that the spring arm (14) includes a center layer (50) and two cover layers (52) coupled thereto, the piezoelectric transducers (26) in each case being situated between the center layer (50) and one of the cover layers (52).

4. Force generator according to claim 3, characterized in that the cover layers (52) at both ends extend farther than the piezoelectric transducers (26), and are connected there to the center layer (50) via support sections (54), the piezoelectric transducers (26) being supported on the support sections (54) so that only the center layer (50) is present in the middle area of the spring arm (14).

5. Force generator for mounting on a structure (12) in order to introduce vibrational forces into the structure in a controllable manner for influencing vibration, comprising at least one spring arm (14) having a fixed end (16) for fastening to the structure (12), and having a vibrating end (18) to which an inertial mass (24) is fastened via a bending arm (22) extending in the direction of the fixed end (16), at least one piezoelectric transducer (26) being mounted on the spring arm (14) for the bending deformation thereof, characterized in that at least one piezoelectric transducer (26) is mounted at both ends (16, 18) of the spring arm (14), two guide springs (40) being situated on both sides of the spring arm (14), parallel thereto, one end of each guide spring likewise being fastened to the structure (12), and the second end of each guide spring, together with the vibrating end of the spring arm (14), being fixedly mounted on a connecting part (42), the bending arm (22) being mounted on the connecting part (42).

6. Force generator for mounting on a structure (12) in order to introduce vibrational forces into the structure in a controllable manner for influencing vibration, comprising at least one spring arm (14) having a fixed end (16) for fastening to the structure (12), and having a vibrating end (18) to which an inertial mass (24) is fastened via a bending arm (22) extending in the direction of the fixed end (16), at least one piezoelectric transducer (26) being mounted on the spring arm (14) for the bending deformation thereof, characterized in that at least one piezoelectric transducer (26) is mounted on both ends (16, 18) of the spring arm (14), at least two spring arms (14a, 14b) of the same type provided with piezoelectric transducers being provided parallel to one another, the fixed ends of the spring arms being fastened to the structure (12), and the vibrating ends of the spring arms being fixedly connected to one another via a connecting part (42), the bending arm (22) being mounted on the connecting part.

7. Force generator according to one of the two preceding claims, characterized in that the length of the bending arm (14) is such that the distance of the center of gravity of the inertial mass (24) from the fixed end (16) is less than 20% of the length of the spring arm (14).

8. Force generator according to claim 1 or 7, characterized in that a second spring arm (14g, 14j, 14k) extending in the opposite direction and having piezoelectric transducers (26) attached at both ends is mounted at the end of each spring arm (14), and a bending arm (22, 22a, 22b) having an inertial mass (24, 24a, 24b) is mounted at the other end of each spring arm.

9. Force generator for mounting on a structure (12) in order to introduce vibrational forces into the structure in a controllable manner for influencing vibration, at least one spring arm (14) having a fixed end (61) for fastening to the structure (12), and having a vibrating end which is coupled to an inertial mass (24), at least one piezoelectric transducer (62) contacting the spring arm (14) for the bending deformation thereof, at least one lever arm (60) being provided on the spring arm (14) in the area of the fixed end (61), and a piezoelectric transducer (62) being supported at one end on the structure (12a), and at its second end being supported on the lever arm (60) for bending the spring arm (14), characterized in that two lever arms (60a, 60b) extending in opposite directions are mounted on the spring arm (14), and a piezoelectric transducer (62a, 62b) is supported on each of the lever arms (60a, 60b), and the respective second end of the lever arms (60a, 60b) is supported on the structure (12a).

10. Force generator according to claim 9, characterized in that a compression spring or tension spring which is fastened to the structure (12) and which counteracts the piezoelectric transducer (62) is mounted on the at least one lever arm (60a, 60b) or a second lever arm (60a, 60b).

11. Force generator according to claim 9, characterized in that the fixed end of the spring arm (14) is designed as a preferably convex pitch surface (70) which is supported against a conversely shaped, in particular concave, opposite pitch surface (72) on the structure side.

12. Force generator according to claim 9, characterized in that the two piezoelectric transducers (62) which contact the lever arms (60) at their other ends are fastened to one intermediate support (80) each, and the two intermediate supports (80) are in each case fastened to an additional piezoelectric transducer (82), each extending essentially parallel to the two first piezoelectric transducers (62) and being controllable out of phase with same, and at its other end being supported on the structure (12).

13. Force generator according to claim 9, characterized in that the two piezoelectric transducers (62) which contact the lever arms (60) at their respective other ends contact a centrally rotatably fixed rocker part (90), and two additional piezoelectric transducers (82) contact at the rocker part (90), each extending parallel to the two first piezoelectric transducers (62) and being controllable out of phase with same, and at its other end being supported on the structure (12).

14. Force generator according to one of the preceding claims, characterized in that the inertial mass (24) and/or the bending arm (22) together with the inertial mass (24) is/are exchangeable.

15. Force generator for mounting on a structure (12)) in order to introduce vibrational forces into the structure in a controllable manner for influencing vibration, comprising at least one spring arm (14) having a fixed end (61) for fastening to the structure (12), and having a vibrating end which is coupled to an inertial mass (24), at least one piezoelectric transducer (62) contacting the spring arm (14) for the bending deformation thereof, characterized in that three mutually parallel spring arms (14, 140) are provided, each being supported on the structure (12) at one end, and at the other end being fastened to a connecting part (130), two projecting lever arms (60) being provided on the middle spring arm (14), and on which two piezoelectric transducers (62) are each supported at their one end, and at their respective second end the piezoelectric transducers (62) each being supported via a bar segment (132) connected to the connecting part, wherein the bar segments (132), the connecting part (130), and the piezoelectric transducers (62) together form the inertial mass.

16. Force generator according to claim 15, characterized in that the distance between the bar segments (132) and the outer spring arms (42) is selected in such a way that stops are formed which prevent damage to the force generator due to excessive deflections.

17. Aircraft, including at least one sensor (106) for detecting vibrations, at least one force generator (10) according to one or more of the preceding claims, and a control unit (114) for controlling the at least one force generator (108) on the basis of the signals of the at least one sensor (106).

18. Aircraft according to claim 17, characterized in that the control unit (114) has the rotational speed of a drive rotor (107) as a further manipulated variable.
